(19) United States
(12) Patent Application Publication
(10) Pub. No.: US 2007/0194755 A1
(43) Pub. Date: Aug. 23, 2007

(54) System and method for multiple battery testing

(75) Inventors: Surender Makhija, Brookfield, WI (US); Steve Sparacino, Portage, MI (US); Weixing Xia, Portage, MI (US); Dennis Robinson, Portage, MI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 11/356,250

(22) Filed: Feb. 17, 2006

(51) Int. Cl. H02J 7/00

(52) U.S. Cl. 320/116

(57) ABSTRACT

The present invention provides a system and method that enables a user to easily and efficiently determine a battery pack's rated current capacity without knowing the configuration of the batteries within the battery pack. Thus, the present invention enables a user to avoid manually calculating the battery pack's configuration. Furthermore, in some situations, the present invention enables a user to avoid having to disconnect and individually test the battery pack's batteries.

### FIELD OF THE INVENTION

The present invention relates generally to battery testers. More particularly, the invention relates to testing a battery pack without knowing the configuration of the batteries within the battery pack.

### BACKGROUND OF THE INVENTION

A large amount of electrical current is necessary to start a heavy-duty vehicle's engine. Battery packs are often relied upon to provide such electrical current. A faulty battery pack can result in the vehicle's failure to start. Thus, upon the vehicle's failure to start, it is desirable to test the vehicle's battery pack to determine whether the battery pack is, indeed, faulty.

Known battery testing equipment compares the battery pack's measured current output capacity to the battery pack's rated current capacity to determine whether the battery pack is supplying adequate current. Thus, it follows, the technician must determine, and input into the testing equipment, the battery pack's rated current capacity before testing. This enables the testing equipment to compare the rated current capacity against the measured current output capacity.

To determine the battery pack's rated current capacity, the technician must first know the battery pack's configuration. The configuration is characterized, in large part, by the individual batteries' arrangement within the battery pack. For example, the technician must specifically identify the parallel and/or serial connections among the batteries. Based on the connections, the technician must then calculate the overall current capacity of the battery pack.

This is a time consuming and costly process. It is hard to determine the battery pack's configuration. The technician can likely determine, by simple observation, the number of batteries within the battery pack, but the technician cannot easily, if at all, determine the parallel and/or serial connections among the batteries. For example, a battery pack comprising four 12-volt batteries could consist of four 12-volt batteries connected in parallel, two pairs of serial connected 12-volt batteries wherein the pairs are connected in parallel, or four 12-volt batteries connected in series. All of the aforementioned configurations are hard to distinguish and all have a different rated current capacity. Thus, to determine the configuration, the technician must spend time studying either an engineering diagram of the battery pack or the actual connections. Not only are these determinations time consuming and costly, they give rise to human error.

Moreover, once the technician determines the battery pack's configuration, he must utilize the information to calculate the battery pack's rated current capacity. These calculations give rise to human error. For example, if the technician incorrectly calculates the rated current capacity, the battery tester would provide incorrect results. Thus, known battery testers depend on human calculations, which are subject to human error.

Therefore, it would be desirable to provide a system capable of determining a battery pack configuration based on easily determined variables. For example, a technician can easily determine the overall voltage of the battery pack, the number of batteries within the battery pack, and the respective voltage and/or current capacity of each battery within the battery pack. Thus, it would be desirable to provide a system and method capable of determining a battery pack's configuration based the aforementioned easily determined variables.

### SUMMARY OF THE INVENTION

The foregoing needs are met, to a great extent, by the present invention, wherein in one aspect a system and method are provided that in some embodiments the present invention provides an easy and efficient way to test a battery pack without knowing the actual battery pack configuration.

In accordance with one aspect of the present invention is a method for determining a charging characteristic of a battery pack, comprising: receiving an overall voltage of the battery pack, wherein a plurality of individual batteries is disposed in battery pack; receiving a number of batteries corresponding to the individual batteries disposed in the battery pack; receiving an individual battery property common to all individual batteries disposed in the battery pack; and determining the charging characteristic of the battery pack based on the overall voltage of the battery pack, the number of batteries, and the individual battery property.

In accordance with another aspect of the present invention is a system for determining a charging characteristic of a battery pack, comprising: means for receiving an overall voltage of the battery pack, wherein a plurality of individual batteries is disposed in battery pack; means for receiving a number of batteries corresponding to the individual batteries disposed in the battery pack; means for receiving an individual battery property common to all of the individual batteries disposed in the battery pack; and means for determining the charging characteristic of the battery pack based on the overall voltage of the battery pack, the number of batteries, and the individual battery property.

In accordance with yet another aspect of the present invention is an apparatus for testing a battery pack, comprising: an input device configured to receive an overall voltage of the battery pack, a number of individual batteries disposed in the battery pack, and an individual current capacity common to the individual batteries disposed in the battery pack; and a processor configured to determine an overall rated current capacity of the battery pack based on the overall voltage of the battery pack, the number of individual batteries disposed in the battery pack, and the individual current capacity of the individual batteries disposed in the battery pack.

There has thus been outlined, ratherbroadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a battery pack having four batteries connected in parallel.

FIG. 2 is a perspective view illustrating a battery pack having four batteries connected in series.

FIG. 3 is a perspective view illustrating a battery pack having two pairs of batteries connected in parallel, and the pairs are connected to each other in series.

FIG. 4 is a perspective view illustrating a battery pack having two pairs of batteries connected in series, and the pairs are connected to each other in parallel.

FIG. 5 is a perspective view of a battery testing system according to an embodiment of the invention.

FIG. 6 is a flowchart illustrating the steps that maybe followed in accordance with an embodiment of the invention.

### DETAILED DESCRIPTION

The invention will now be described with reference to the drawing figures, in which like numerals refer to like parts throughout. An embodiment in accordance with the present invention provides a system and method that enables a user, such as a technician, to easily and efficiently determine a battery pack's rated current capacity, e.g., the spec Cold Cranking Amperage, without knowing the configuration of the batteries within the battery pack. It is important to determine the battery pack's rated current capacity, which is necessary for testing the battery pack. For example, to determine a battery pack's condition, the testing equipment compares the battery pack's measured current output capacity to its rated current capacity. If the measured current output capacity is proximate to the rated current capacity, then the battery pack is in good condition.

Not only does the current invention enable the user to avoid manually determining the battery pack's configuration, in some situations, the user also avoids disconnecting and individually testing the battery pack's batteries. For example, upon the vehicle's failure to start, it is desirable to test the vehicle's battery pack to determine whether the battery pack is faulty. Utilizing the present invention, the user can quickly test the entire battery pack, instead of separately testing each battery within the battery pack. If the battery pack is in good condition, then the user has successfully tested the battery pack without disconnecting the batteries, and the user can utilized the saved time to troubleshoot other parts of the vehicle. Moreover, even if the battery pack is faulty, the present invention can save time by notifying the user whether the batteries are connected in series. If the batteries are connected in series, then the batteries can be individually tested while connected. Thus, the user saves time by not having to disconnect the batteries before individual battery testing. However, if the batteries configurations contain a parallel connection, then the batteries must be disconnected before individual battery testing can occur.

The present invention is capable of determining a battery pack's configuration and its rated current capacity based on several easily determined variables. For example, the user can input the overall voltage of the battery pack, the number of batteries within the battery pack, and the respective voltage or current capacity of each battery within the battery pack. Based on the aforementioned user-inputs, the present invention is capable of determining the battery pack's configuration and its rated current capacity. A battery tester can then test the battery pack by comparing its measured current output capacity to its rated current capacity. Thus, the present invention facilitates an easy and efficient battery pack test.

It is desirable to test the battery pack without first determining the configuration of the batteries within the battery pack because determining the configuration is costly and time consuming. This is because the technician must determine the specific connections among the various batteries within the battery pack. There are dozens of possible combinations of connections within the battery pack. For example, a 12-volt charging system can comprise the following configurations: two 12-volt batteries connected in parallel; four 12-volt batteries connected in parallel; and two pairs of serial connected 6-volt batteries wherein the pairs are connected in parallel. A 24-volt charging system can comprise, for example, the following configurations: two 12-volt batteries connected in series; and two pairs of serial connected 12-volt batteries wherein the pairs are connected in parallel. A 6-volt charging system, for example, comprises any number of 6-volt batteries connect in parallel.

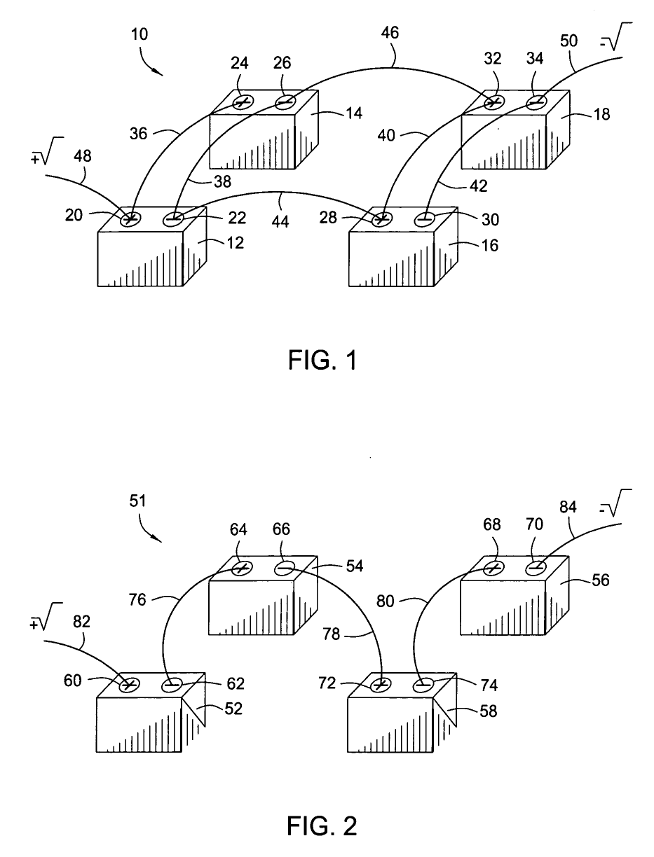

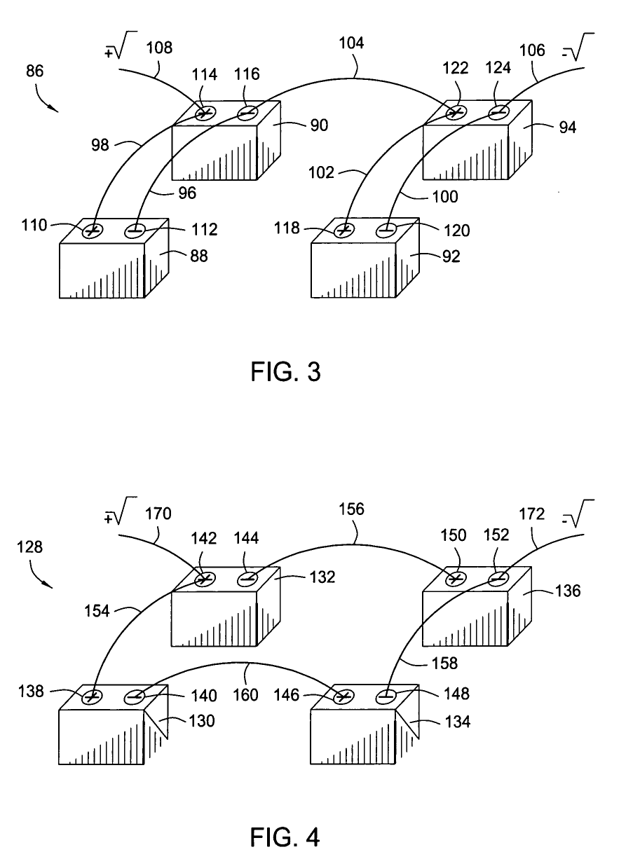

Various exemplary battery configurations are illustrated in FIGS. 1-4: FIG. 1 illustrates four batteries connected in parallel; FIG. 2 illustrates four batteries connected in series; FIG. 3 illustrates two pairs of parallel connected batteries, and the pairs are connected in series; and FIG. 4 illustrates two pairs of serial connected batteries, and the pairs are connected in parallel. As one can gleam from FIGS. 1-4, it is difficult to determine the respective configurations of the various battery packs. This determination is even more difficult when the battery pack is installed in a constricted space, e.g., within a heavy-duty vehicle's battery housing.

FIG. 1 is a perspective view illustrating a battery pack 10 having four batteries 12, 14, 16, and 18 connected in parallel. In this example, each battery has a rated voltage output of 12 volts and a rated current capacity of 1500 Cold-Cranking Amperage (CCA). It should be appreciated that each battery can be of voltage other than 12 volts, such as 6 volts, and it should further be appreciated that each battery can be of a current capacity other than 1500 CCA, such as 750 CCA. Because greater current capacity can be obtained by connecting multiple batteries in parallel, this parallel configuration may, for example, be found in heavy-duty vehicles that require more than 1500 CCA.

As a result of the parallel connection, the battery pack's 10 current capacity equals the combined current capacity of the batteries 12, 14, 16, and 18, and the battery pack's 10 operating voltage equals the average voltage output of the respective batteries' 12, 14, 16, and 18. Thus, the exemplary battery pack 10 has a rated current capacity of 6000 CCA (4×1500 CCA) and a rated operating voltage of 12 volts.

As illustrated in FIG. 1, battery 12 has a positive terminal 20 and a negative terminal 22. Battery 12 is connected in parallel to battery 14 having a positive terminal 24 and a negative terminal 26. Cable 36 connects positive terminal 20 to positive terminal 24, and cable 38 connects negative terminal 22 to negative terminal 26. Likewise, battery 16 has a positive terminal 28 and a negative terminal 30. Battery 16 is connected in parallel to battery 18 having a positive terminal 32 and a negative terminal 34. Cable 40 connects positive terminal 28 to positive terminal 32, and cable 42 connects negative terminal 30 to negative terminal 34. Cable 44 connects negative terminal 22 to negative terminal 30, and cable 46 connects positive terminal 24 to positive terminal 32. The aforementioned connections create a battery pack 10 comprising four batteries 12, 14, 16, and 18 connected in parallel. Thus, battery pack 10 outputs a voltage equal to the average voltage of the batteries 12, 14, 16, and 18, and the battery pack 10 outputs an amperage equal to the aggregate of the amperage of the batteries 12, 14, 16, and 18, as stated above.

A technician attempting to manually calculate the rated current capacity of battery pack 10 would have to make observations much like those presented in the previous paragraph. This manual process is time consuming and gives rise to human error. Instead, using the present invention, a technician can obtain the current capacity of battery pack 10 by, for example, simply inputting the following data into the present invention: the battery pack comprises four 1500 CCA batteries; and the charging system, in which the battery is utilized, is a 12-volt charging system.

FIG. 2 is a perspective view illustrating a battery pack 51 having four batteries 52, 54, 56, and 58 connected in series. A typical automotive battery has an operating voltage of either 6 volts or 12 volts. However, some heavy-duty vehicles require more than 6 volts or 12 volts. In the example illustrated in FIG. 2, each battery has a rated voltage output of 12 volts and a rated current capacity of 1500 CCA. Because greater voltage output can be obtained by connecting multiple batteries in series, this serial configuration may, for example, be found in heavy-duty vehicles that require more than 12 volts.

As illustrated in FIG. 2, battery 52 has a positive terminal 60 and a negative terminal 62. Battery 52 is connected in series to battery 54 having a positive terminal 64 and a negative terminal 66. Cable 76 connects negative terminal 62 to positive terminal 64, and cable 82 provides a positive voltage output from positive terminal 60. For example, cable 82 can be connected to a charging system. Battery 54 is connected in series to battery 58 having a positive terminal 72 and a negative terminal 74. Cable 78 connects negative terminal 66 to positive terminal 72. Likewise, battery 58 is connected in series to battery 56 having a positive terminal 68 and a negative terminal 70. Cable 80 connects negative terminal 74 to positive terminal 68, and cable 84 provides a negative voltage output from negative terminal 70. For example, cable 84 can be connected to a charging system. The aforementioned connections create a battery pack 51 comprising four batteries 52, 54, 56, and 58 connected in series. Thus, battery pack's 51 rated current capacity is 1500 CCAs, which is equal to the average current capacity of batteries 52, 54, 56, and 58, and the battery pack's 51 rated voltage output is 48 volts, which is equal to the aggregated voltage of batteries 52, 54, 56, and 58.

A technician attempting to manually calculate the rated current capacity of battery pack 51 would have to make observations much like those presented in the previous paragraph. This manual process is time consuming and gives rise to human error. Instead, using the present invention, a technician can obtain the current capacity of battery pack 51 by simply inputting into the present invention the number of batteries within the battery pack, the rated current capacity of the individual batteries, and the overall voltage rating of the charging system.

FIG. 3 is a perspective view illustrating battery pack 86 having two pairs of parallel connect batteries 88, 90 and 92, 94 connected to each other in series. FIG. 4 is a perspective view illustrating battery pack 128 having two pairs of batteries connected in series 130, 134 and 132, 136, and the pairs are connected to each other in parallel. The individual batteries presented in FIGS. 3 and 4 have a 1500 CCA rated current capacity and a 12 volt rated voltage output. Some heavy-duty vehicles require more than 1500 CCA and more than 12 volts. Thus, these heavy-duty vehicles utilize battery packs comprising a combination of serial and parallel connected batteries.

As illustrated in FIG. 3, battery pack 86 includes battery 88 having a positive terminal 110 and a negative terminal 112. Battery 88 is connected to battery 90 having a positive terminal 114 and a negative terminal 116. Cable 98 connects positive terminal 110 to positive terminal 114, and cable 96 connects negative terminal 112 to negative terminal 116. Likewise, battery 92 has a positive terminal 118 and a negative terminal 120. Battery 92 is connected to battery 94 having a positive terminal 122 and a negative terminal 124. Cable 102 connects positive terminal 118 to positive terminal 122, and cable 100 connects negative terminal 120 to negative terminal 124. Cable 104 connects negative terminal 116 of battery 90 to positive terminal 122 of battery 94. Thus, the two pairs of parallel connected batteries 88, 90 and 92, 94 are connected to each other in series.

Battery pack 86 has rated voltage output of 24 volts, which is equal to the average rated voltage of batteries 88 and 90 plus the average rated voltage of batteries 92 and 94. The battery pack 86 has a rated current capacity of 3000 CCAs, which is equal to the average of the aggregated rated current capacities of batteries 88 and 90 and the aggregated rated current capacities of batteries 92 and 94.

As illustrated in FIG. 4, battery pack 128 includes battery 130 having a positive terminal 138 and a negative terminal 140. Battery 130 is connected to battery 132 having a positive terminal 142 and a negative terminal 144. Cable 154 connects positive terminal 138 to positive terminal 142, and cable 170 provides a positive voltage output from positive terminal 142. Cable 170 can be, for example, connected to a charging system. Likewise, battery 134 has a positive terminal 146 and a negative terminal 148. Battery 134 is connected to battery 136 having a positive terminal 150 and a negative terminal 152. Cable 158 connects negative terminal 148 to negative terminal 152, and cable 172 provides a negative voltage output from negative terminal 152. Cable 172 can be, for example, connected to a charging system. Cable 156 connects negative terminal 144 of battery 132 to positive terminal 150 of battery 136, and cable 160 connects negative terminal 140 of battery 130 to positive terminal 146 of battery 134. Thus, the two pairs of serial connected batteries 130, 134 and 132, 136 are connected to each other in parallel.

Battery pack 128 has a rated voltage output of 24 volts, which is equal to the average rated voltage of batteries 130 and 134 plus the average rated voltage of batteries 132 and 136. The battery pack 128 has a rated current capacity of 3000 CCAs, which is equal to the average of the aggregated rated current capacities of batteries 130 and 134 and the aggregated rated current capacities of batteries 132 and 136.

If the batteries and cables of battery pack 128 have the same specifications as those of battery pack 86, then the respective rated current capacities and rated voltage outputs of battery pack 128 and battery pack 86 are equal. A technician attempting to manually calculate the rated current capacities of battery packs 86 and 128 would have to make observations much like those presented in the previous paragraphs. This manual process is time consuming and gives rise to human error. Instead, using the present invention, a technician can obtain the rated current capacity of battery packs 86 and 128 simply by inputting into the present invention the number of batteries within each battery pack 86 and 128, the rated current capacity of individual batteries, and the overall voltage of the charging system. Based on the inputted data, the present invention can determine the overall rated current capacity of battery packs 86 and 128.

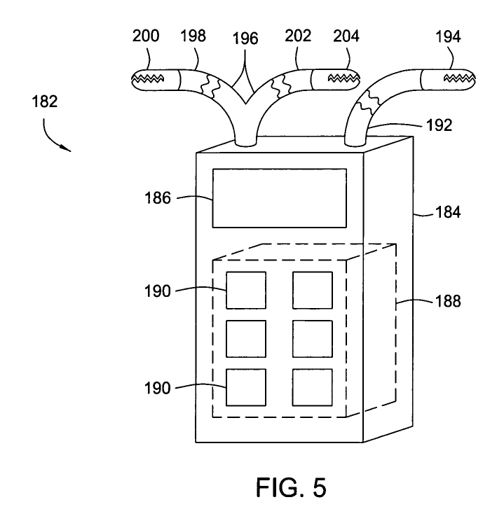

FIG. 5 is a perspective view of an exemplary battery testing apparatus 182 according to an embodiment of the present invention. The battery testing apparatus 182 contains a housing 184, a display 186, an internal processor 188, and an input device 190. The input device 190 can be, for example, buttons, dials, or a keyboard. Thus, any manner by which a user can enter information can be used.

A cable 192 extends from the housing 184 and is configured to measure a current flow in the battery pack 10, 51, 86, or 128 using an amprobe clamp 194. The apparatus 182 also contains cables 196. A first testing cable 198 is configured to couple to the positive voltage output +V of battery packs 10, 51, 86, and 128 using a battery clamp 200. Likewise, a second testing cable 202 is configured to couple to the negative voltage output −V of battery packs 10, 51, 86, and 128 using a battery clamp 204.

Alternatively, cable 198 may connect to the negative voltage output −V of battery packs 10, 51, 86, and 128, and cable 202 may connect to the positive voltage output +V of battery packs 10, 51, 86, and 128. The clamps 200 and 204 may be alligator clamps or any suitable type of attaching device. Although shown as a separate device, the battery testing apparatus 182 may be combined with any type of electrical device such as an automotive scan tool or an amprobe, for example.

The display 186 is configured to show step-by-step detailed instructions and is driven by the processor 188. These instructions will instruct the technician on where and when to attach a particular clamp or when to remove a particular clamp. The display 186, among other things, also shows the battery packs' 10, 51, 86, and 128 rated current capacities, the battery packs' 10, 51, 86, and 128 measured current output capacities.

The display 186 may be a Liquid Crystal Display (LCD) or the like. The LCD may show letters and numbers. A Video Graphics Array (VGA) display will be able to show images instead of characters. The display 186 may include either an LCD screen, a VGA screen or a combination of both.

The battery testing device 182 also includes an internal processor 188. The processor 188 is configured to receive and record the battery packs' 10, 51, 86, and 128 actual current output capacity measurement and actual voltage output measurements. The processor 188 is further configured to receive user-inputs and determine the battery packs' 10, 51, 86, and 128 configuration based on the received data and inputs.

The processor 188 is programmed to apply accepted battery concepts: batteries connected in series produce a voltage equal the aggregated voltage of all connected batteries and have a current capacity equal to the average current capacity of all connected batteries; and batteries connected in parallel produce a voltage equal the average voltage of all connected batteries and have a current capacity equal to the aggregated current capacities of all connected batteries.

In an embodiment, the processor 188 is programmed to determine battery configurations based on the user-inputs without applying a mathematical formula. In other words, the processor 188 is programmed to select the battery configuration upon receiving specific combinations of user-inputs. Some of these possible combination are discussed below.

For example, the processor 188 can be programmed with possible battery configurations and corresponding current capacities for a 12-volt charging system. If the user-inputs indicate a 12-volt charging system having two 12 volt batteries, then the processor 188 is programmed to indicate that the battery configuration is two parallel connected 12 volt batteries. If the user-inputs indicate a 12-volt charging system having four 12 volt batteries, then the processor 188 is programmed to indicate that the battery configuration is four parallel connected 12 volt batteries. If the user-inputs indicate a 12-volt charging system having four 6 volt batteries, then the processor 188 is programmed to indicate that the battery configuration is two pairs of serial connected 6 volt batteries, and the pairs are connected to each other in parallel. The foregoing possible battery configurations are exemplary and are included for illustrative purposes.

Also for example, the processor 188 can be programmed with possible battery configurations and corresponding current capacities for a 24-volt charging system. If the user-inputs indicate a 24-volt charging system having two 12 volt batteries, then the processor 188 is programmed to indicate that the battery configuration is two serial connected 12 volt batteries. If the user-inputs indicate a 24-volt charging system having four 12 volt batteries, then the battery configuration is two pairs of serial connected 12 volt batteries, and the pairs are connected to each other in parallel. The foregoing possible battery configurations are exemplary and are included for illustrative purposes.

Also for example, the processor 188 can be programmed with at least a possible battery configuration and various current capacities for a 6-volt charging system. If the user-inputs indicate a 6-volt charging system having any number of 6-volt batteries, then the processor 188 is programmed to indicate that the battery configuration is all batteries are connected in parallel. The foregoing possible battery configuration is exemplary and is included for illustrative purposes.

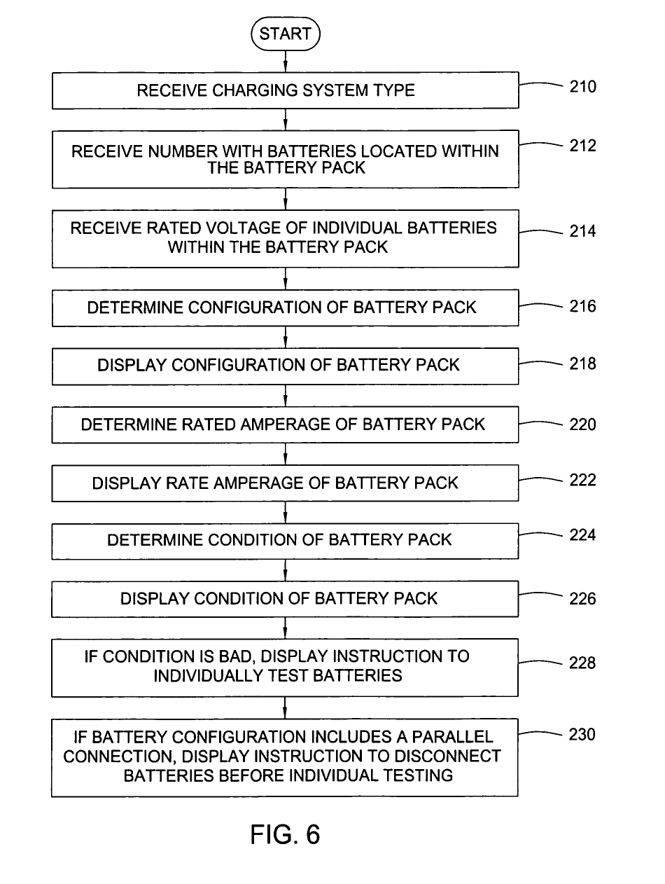

As shown in FIG. 6, the system first receives a charging system type in step 210. The user, for example, can enter the charging system type via the input device 190. The charging system type can be the total voltage output of the battery pack 10, 51, 86, or 128 being tested. The charging system type is easily identifiable because it is usually printed on the equipment in which the battery pack 10, 51, 86, 128 is employed and is usually either 6 volts, 12 volts, or 24 volts. For example, if the battery pack 10, 51, 86, or 128 is employed in a heavy-duty vehicle, the charging system type will be printed on the vehicle, e.g., on the vehicle's alternator or on literature accompanying the vehicle.

Once the system has received the charging system type, the system next receives the number of batteries within the battery pack 10, 51, 86, or 128 in step 212. For example, the processor 188 can prompt the user, via the display 186, to enter the number of batteries into the input device 190. The number of batteries is easily determined by a physical inspection of the battery pack 10, 51, 86, or 128. Next, in step 214, the system receives an input a characteristic common to all batteries within the battery pack 10, 51, 86, or 128. For example, the system prompts the user to input the individual batteries' rated current capacities. Rated current capacity is easily determinable because it is printed on the battery and, in the heavy-duty vehicle context, the rated current capacity is usually 1500 CCA. Also for example, the system prompts the user to input the individual batteries' voltage ratings. Voltage rating is easily determinable because it is printed on the battery and, in the heavy-duty vehicle context, the voltage rating is usually either 6 volts or 12 volts.

Once the aforementioned inputs are received, the system then determines the configuration of the battery pack 10, 51, 86, or 128, in step 216. For example, if the charging system type is a 24-volt charging system, the number of batteries is 2, the battery characteristic is a voltage rating of 12 volts, then processor 188 applies the aforementioned accepted battery concepts or accesses the programmed battery configurations to determine that the battery pack comprises two serial connected 12 volt batteries. Other example battery configurations are discussed above. Moreover, it should be appreciated that the battery configuration can be a configuration other than those discussed in this application. Once the battery configuration has been determined, the system proceeds to step 218 and presents the configuration details to the user via the display 186.

In addition to, or in lieu of, determining the configuration of the battery pack 10, 51, 86, or 128, in step 220 the system determines the rated current capacity of the battery pack 10, 51, 86, or 128. For example, if the charging system type is a 24-volt charging system, the number of batteries is 2, the battery characteristic is a voltage rating of 12 volts and a rated current capacity of 1500 CCA, then processor 188 applies the aforementioned accepted battery concepts or accesses the possible battery configurations and corresponding rated current capacities to determine that the current capacity of the battery pack 10, 51, 86, 128 is 1500 CCA. Once the current capacity has been determined, the system proceeds to step 222 and presents the current capacity to the user via the display 186.

Next, the system proceeds to step 224 and determines the condition of the battery pack 10, 51, 86, or 128. For example, the system compares the measured current output capacity of the battery pack 10, 51, 86, or 128, which can be previously determined using known testing devices, to the rated current capacity of the battery pack 10, 51, 86, or 128. If the measured current output capacity is proximate to the rated current capacity, then the system determines that the condition of the battery pack 10, 51, 86, or 128 is good. However, if the measured current output capacity is not proximate to the rated current capacity, then the system determines that the condition of the battery pack 10, 51, 86, or 128 is faulty. Upon determining the condition of the battery pack 10, 51, 86, or 128, the system presents the condition to the user via the display 186 in step 226.

If the condition of the battery pack 10, 51, 86, or 128 is faulty, then the system proceeds to step 228 and instructs the user to individually test the batteries located within the battery pack 10, 51, 86, or 128 to determine which batteries are faulty. Next, the system proceeds to step 230 and, if the battery configuration includes a parallel connection, then the batteries are dependent on each other and, thus, the system instructs the user to disconnect all batteries within the battery pack 10, 51, 86, or 128 before individual testing. If, however, the battery configuration does not include a parallel connection, then the batteries are operating independently and, thus, the system instructs the operator to proceed with individual testing without disconnecting the batteries. It can be very advantageous to prompt the user not to disconnect the batteries before testing because disconnecting a battery pack, especially in the field, can be time consuming.

Although examples of the present invention are shown as applied to battery packs included in heavy-duty vehicles, it will be appreciated that the present invention may also be applied with any kind of power system having batteries and a battery pack. Also, although the present invention is useful to determine the battery pack's rated current capacity, it can also be used determine other characteristic of the battery pack such as rated voltage output.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents maybe resorted to, falling within the scope of the invention.

What is claimed is:

1. A method for determining a charging characteristic of a battery pack, comprising:
receiving an overall voltage of the battery pack, wherein a plurality of individual batteries is disposed in battery pack;
receiving a number of batteries corresponding to the individual batteries disposed in the battery pack;
receiving an individual battery property common to all individual batteries disposed in the battery pack; and
determining the charging characteristic of the battery pack based on the overall voltage of the battery pack, the number of batteries, and the individual battery property.

2. The method of claim 1, wherein the individual battery property is an individual rated current capacity.

3. The method of claim 1, wherein the battery pack characteristic is an overall battery pack rated current capacity.

4. The method of claim 1, wherein the battery pack characteristic is a configuration of the individual batteries disposed in the battery pack.

5. The method of claim 4, wherein the configuration is a number of parallel connections among the individual batteries

6. The method of claim 4, wherein the configuration is a number of serial connections among the individual batteries.

7. The method of claim 3, further comprising determining a condition of the battery pack.

8. The method of claim 7, wherein determining the condition of the battery pack comprises the steps of determining a measured current output capacity of the battery pack and comparing the measured current output capacity to the overall battery pack rated current capacity.

9. The method of claim 8, wherein the condition of the battery pack is selected from a group consisting of good and faulty.

10. The method of claim 9, wherein the condition of the battery pack is good when the measured current output capacity is proximate to the battery pack rated current capacity.

11. The method of claim 9, wherein the condition of the battery pack is faulty when the measured current output capacity is not proximate to the battery pack rated current capacity.

12. The method of claim 9, further comprising instructing individual testing of the individual batteries disposed in the battery pack when the condition of the battery pack is faulty.

13. The method of claim 12, further comprising instructing disconnection of the individual batteries disposed in the battery pack prior to individual testing when the charging characteristic is a battery pack configuration that includes a number of parallel connections.

14. A system for determining a charging characteristic of a battery pack, comprising:
means for receiving an overall voltage of the battery pack, wherein a plurality of individual batteries is disposed in battery pack;
means for receiving a number of batteries corresponding to the individual batteries disposed in the battery pack;
means for receiving an individual battery property common to all of the individual batteries disposed in the battery pack; and
means for determining the charging characteristic of the battery pack based on the overall voltage of the battery pack, the number of batteries, and the individual battery property.

15. The system of claim 14, wherein the individual battery property is an individual rated current capacity.

16. The system of claim 14, wherein the battery pack characteristic is an overall battery pack rated current capacity.

17. The system of claim 14, wherein the battery pack characteristic is a configuration of the individual batteries disposed in the battery pack, and the configuration specifies a number of parallel connections among the individual batteries

18. The system of claim 14, wherein the battery pack characteristic is a configuration of the individual batteries disposed in the battery pack, and the configuration specifies a number of serial connections among the individual batteries.

19. The system of claim 16, further comprising means for determining a condition of the battery pack.

20. The system of claim 19, wherein the means for determining a condition of the battery pack comprises means for determining a measured current output capacity of the battery pack and means for comparing the measured current output capacity to the overall battery pack rated current capacity.

21. An apparatus for testing a battery pack, comprising:
an input device configured to receive an overall voltage of the battery pack, a number of individual batteries disposed in the battery pack, and an individual current capacity common to the individual batteries disposed in the battery pack; and
a processor configured to determine an overall rated current capacity of the battery pack based on the overall voltage of the battery pack, the number of individual batteries disposed in the battery pack, and the individual current capacity of the individual batteries disposed in the battery pack.

22. The apparatus of claim 21, further comprising:
a first clamp connected to a positive terminal of the battery pack and configured to transmit a first current measurement to the processor; and
a second clamp connected to a negative terminal of the battery pack and configured to transmit a second current measurement to the processor;
wherein, the processor is further configured to determine an overall measured current output capacity of the battery pack based on the first and second current measurements.

23. The apparatus of claim 22, wherein the processor determines a condition of the battery pack by comparing the overall rated current capacity to the overall measured current output capacity.
